(19) United States
(12) Patent Application Publication
(10) Pub. No.: US 2012/0299420 A1
(43) Pub. Date: Nov. 29, 2012

(54) BEARING ARRANGEMENT FOR AN ELECTRIC ENGINE

(75) Inventors: Stephan SCHARR, Friedrichshafen (DE); Timo WEHLEN, Friedrichshafen (DE)

(73) Assignee: ZF FRIEDRICHSHAFEN AG, Friedrichshafen (DE)

(21) Appl. No.: 13/465,184

(22) Filed: May 7, 2012

(30) Foreign Application Priority Data
May 26, 2011 (DE) 10 2011 076 530.1

(51) Int. Cl. H02K 7/08

(52) U.S. Cl. 310/90

(57) ABSTRACT

A bearing assembly for an electric machine with a stator (1) and a rotor (2) is proposed such that the rotor (2), with its rotor shaft (3), is mounted by bearings (4, 4A) on the housing. The mounting is such that the bearings (4, 4A) are thermally separated from the rotor shaft (3) in order to reduce heat transfer therebetween.

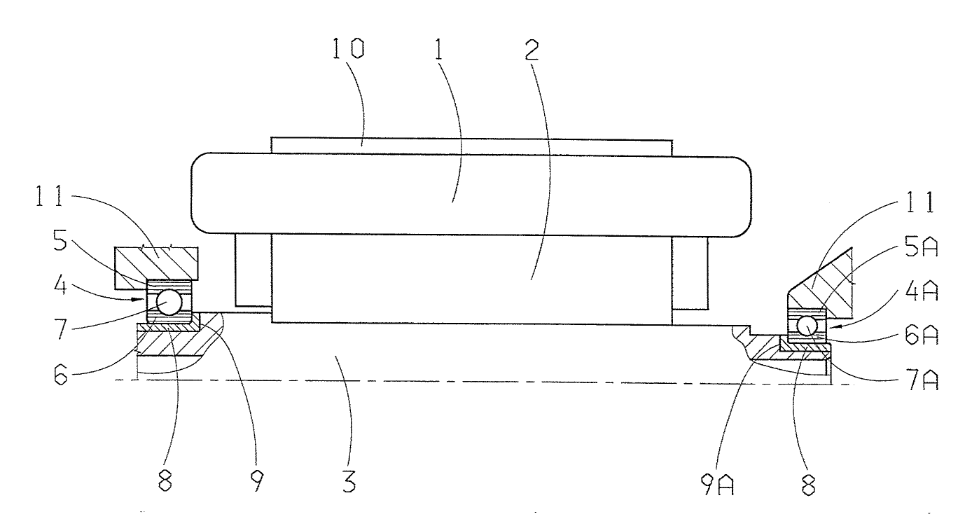

The present invention concerns a bearing arrangement for an electric engine, of the type defined in more detail in the preamble of claim 1.

For example, from the document DE 10 2009 031 869 A1 an axle drive unit is known, which comprises an electric machine drivingly connected to an axle differential transmission by way of transmission gearing. The electric machine has a stator and a rotor, which with its rotor shaft is mounted to rotate in a bearing of the electric machine.

During operation of the electric machine, depending on the power demanded and the efficiency, losses can occur which result in the heating of the electric machine and the components adjacent to it. Particularly critical during this is the heating of the rotor shaft and the consequent heating of its bearing assembly. Disadvantageously, heating of the bearing assembly reduces its life.

The purpose of the present invention is to improve a bearing assembly of an electric machine of the type indicated at the start, in particular as regards its life.

Thus, a bearing assembly is proposed for an electric machine for example comprising at least one stator and at least one rotor, the rotor being held and able to rotate by virtue of a rotor shaft or the like supported by bearings fixed on the housing. According to the invention to reduce the heat transfer between the rotor shaft and the bearings, it is provided that the bearings used are thermally separated or insulated from the rotor shaft.

With the bearing assembly according to the invention the transfer of heat from the rotor shaft to the bearings is substantially reduced. Consequently the life of the bearings can be extended without having to improve the cooling system or to use high-grade bearings, whereby manufacturing costs are reduced thanks to the proposed bearing assembly.

For the thermal separation between the rotor shaft and the bearings, a suitable insulating material or the like can be used. For this, the areas or contact surfaces of the bearings that face toward the rotor shaft can be provided with the insulating material for heat insulation purposes. In that the insulating material has an appropriate heat transfer coefficient, the heat transfer is correspondingly impeded. The insulating material can also be used with certain types of press fits and/or transition fits in order to farther enhance the insulating action.

In the context of a particularly advantageous embodiment variant of the invention it can be provided that an adhesive is used as the insulating material, which besides the insulating function also has a fixing action so that, for example in the case of fixed-loose bearings, no additional retaining ring is needed to realize the fixed bearing. For example a bonded shrink fit can be provided between the bearing concerned and the rotor shaft. Particularly in high-speed applications, due to the action of centrifugal forces the operating reliability of the electric machine is increased since retaining rings can only withstand such demands up to a point.

The present invention will be explained in more detail with reference to the drawing. As an example, the sole FIGURE of the invention shows a schematic view of a possible embodiment variant of a bearing assembly according to the invention, with an electric machine.

The electric machine comprises a stator 1, preferably provided with a cooling jacket 10. Inside the stator 1 is a rotor 2 that rotates with its rotor shaft 3. Then rotor shaft 3 is mounted to rotate by virtue of a bearing assembly supported on a housing 11 of the electric machine (only part of which is indicated). As the bearing assembly roller bearings 4, 4A are provided. The roller bearings 4, 4A each have an inner bearing ring 6, 6A and an outer bearing ring 5, 5A, between which rolling elements 7, 7A are held.

According to the invention it is provided that the roller bearings 4, 4A are thermally separated from the rotor shaft 3 in order to reduce heat transfer between them. For this, an insulating material 8 is provided between the inner bearing rings 6, 6A and the rotor shaft 3. Preferably an adhesive is used as the insulating material, which besides its insulating action also fixes the inner bearing rings 6, 6A onto the rotor shaft 3. To reduce the heat transfer, the adhesive is applied to the respective contact surfaces between the inner bearing rings 6, 6A and the rotor shaft 3.

In this way, when for example the electric machine is used for powering an axle drive or a single-wheel drive in a vehicle, the heat insulation between the bearing assembly and the rotor shaft 3 can be substantially reduced and therefore the life of the rotor shaft bearing can be extended. Particularly in the case of high-speed machines designed for example as asynchronous machines or even as permanently energized synchronous machines, the use of an adhesive as the insulating material can increase operational reliability, since there is then no need for the otherwise necessary retaining rings.

### INDEXES

1 Stator
2 Rotor
3 Rotor shaft
4, 4A Roller bearings
5, 5A Bearing outer rings
6, 6A Bearing inner rings
7, 7A Rolling elements
8 Insulating material
9, 9A Recessed shoulders in the shaft
10 Cooling jacket
11 Housing

1-6. (canceled)

7. A bearing assembly for an electric engine with a stator (1) and a rotor (2) in which the rotor (2), with its rotor shaft (3), being mounted by bearings (4, 4A) on a housing,
wherein the bearings (4, 4A) are thermally separated from the rotor shaft (3) in order to reduce heat transfer therebetween.

8. The bearing assembly according to claim 7, wherein the bearings (4, 4A) are roller bearings and, in each case, an insulating material (8) is provided between an inner bearing ring (6, 6A) of the roller bearings and the rotor shaft (3).

9. The bearing assembly according to claim 8, wherein an adhesive is provided as the insulating material (8) by which at least one inner bearing ring (6, 6A) is fixed on the rotor shaft (3).

10. The bearing assembly according to claim 7, wherein the bearings are fixed-loose bearings (4, 4A) which, in each case, with their inner bearing rings (6, 6A) are arranged on a recessed shoulder (9, 9A) of the rotor shaft (3).

11. The bearing assembly according to claim 7, wherein the electric machine is provided for powering either an axle drive or a single-wheel drive of a vehicle.

12. The bearing assembly according to claim 7, wherein the electric engine either a high-speed asynchronous machine or a permanently energized synchronous machine.

13. A bearing assembly for an electric engine having a stator and a rotor, the bearing assembly comprising inner bearing rings and outer bearing rings and rolling elements retained between the inner and the outer bearing rings, and the outer bearing rings being directly supported on a housing of the electric engine,
wherein the inner bearing rings are fixed, via an insulating adhesive material, to a rotor shaft which is fixedly conjoined to the rotor such that heat transfer, between the inner bearing rings and the rotor shaft, is reduced, and
the inner bearing rings are supported by recessed shoulders of the rotor shaft and the outer bearing rings are supported at recessed shoulders of the housing.
